(19) United States
(12) Patent Application Publication
(10) Pub. No.: US 2007/0293715 A1
(43) Pub. Date: Dec. 20, 2007

(54) Acceleration-Protection Device

(76) Inventor: Andreas Reinhard, Zurich (CH)

Correspondence Address: WINSTEAD PC, P.O. BOX 50784, DALLAS, TX, 75201, US

(21) Appl. No.: 11/629,260

(22) PCT Filed: Jun. 13, 2005
(86) PCT No.: PCT/CH05/00330

§ 371 Date: Feb. 9, 2007

(30) Foreign Application Priority Data
Jun. 18, 2004 (CH) 1033/04

(51) Int. Cl. B64D 47/00

(52) U.S. Cl. 600/19

(57) ABSTRACT

An acceleration protection device comprising a plurality of pressure cuffs worn on various parts of the body. The cuffs deform when pressurized in such a way as to exert pressure on the body of the wearer so as to offset increased G-forces. Means are provided for tightening and adjusting the protective device to the wearer.

### BACKGROUND OF THE INVENTION

1. Technical Field

This invention relates to a device for protecting the human body against acceleration effects.

2. History of Related Art

Several such devices, in particular protective suits, have become known in the art. As a rule, they protect the human body against downwardly directed acceleration forces in the instantaneous local Z-axis, so-called +G₂ acceleration forces. In modem high-performance aircraft, extreme accelerations of up to +9 G₂ can arise over a longer period, and with high onset rates. All known protective suits operate according to the principle that either the outside pressure around the body of the wearer or the tension in the fabric of a snugly fitting suit is increased. In both cases, this results in a higher internal pressure in the blood vessels of the lower body regions, which diminishes a pooling of blood in the legs, and prevents a dangerous drop in blood pressure in the head. This significantly reduces the danger of a ‘G-LOC’ (G₂ force induced loss of consciousness), an unconsciousness of the wearer under a high G₂ load caused by G₂ acceleration forces, or a G-LOC only sets in at significantly higher G₂-acceleration forces than in an unprotected body. Such protective suits operate either according to pneumatic or hydrostatic principles. One example for a hydrostatic protective suit is disclosed by example in EP 0983190 (WO 99/54200).

One feature common to all of these suits is that they cover large areas of the body surface of the wearer based on their principle of operation. Since the bubbles for generating pressure are water and vapor tight, the wearing comfort of the suits is diminished owing to limited breathing activity and heat accumulation. In addition, the fact that the suits fit snugly based on the principle of operation both in flight and on the ground severely limits the freedom of movement of their wearers.

### SUMMARY OF THE INVENTION

An object to be achieved with this invention has to do with providing a device for protection against exposure to acceleration forces of the kind encountered in flight during directional changes in high-performance aircraft, primarily in the instantaneous and local Z-axis, which exhibits improved wearing comfort and simplified design relative to prior art. The instantaneous local Z-axis describes an axis essentially running from the trunk of the body toward the head parallel to the spinal column of the wearer, regardless of the absolute position of the wearer of the device.

### BRIEF DESCRIPTION OF THE DRAWINGS

A more complete understanding of various embodiments of the Acceleration Protection Device of the present invention may be obtained by reference to the following Detailed Description, when taken in conjunction with the accompanying Drawings, wherein:

FIG. 1 illustrates a first exemplary embodiment of an acceleration protection device, diagrammatic view;

FIG. 2 illustrates a second exemplary embodiment of an acceleration protection device, diagrammatic view;

FIGS. 3a-3e illustrate a diagrammatic view of the fluid cuff of FIG. 2 as follows:

a. isometric

b. longitudinal section, detactivated

c. top view, deactivated

d. longitudinal section, pressurized

e. top view, pressurized

FIG. 4 illustrates a diagrammatic view of a second exemplary embodiment of a fluid cuff, isometric view;

FIG. 5 illustrates a diagrammatic view of a third exemplary embodiment of a fluidic cuff, isometric view;

FIGS. 6a-6b illustrate a diagrammatic view of a fluidic cuff of FIG. 3, longitudinal section, as follows:

a. deactivated

b. activated

FIG. 7 illustrates a diagrammatic view of a fourth exemplary embodiment of a fluidic cuff, longitudinal section;

FIG. 8 illustrates a diagrammatic view of a fifth exemplary embodiment of a fluidic cuff with a piston-cylinder arrangement as the actuator, cross-section;

FIG. 9 illustrates a diagrammatic view of a sixth exemplary embodiment of a cuff shortened by means of a linear actuator;

FIG. 10 illustrates a seventh exemplary embodiment of a cuff, diagrammatic top view;

FIGS. 11a-11b illustrate a diagrammatic view of an eighth exemplary embodiment of a cuff, cross section, as follows:

a. deactivated

b. activated

FIG. 12 illustrates a diagrammatic view of a control and regulating system for operating cuffs according to the invention;

FIG. 13 illustrates a third exemplary embodiment of an acceleration protection device, with reinforcement of the hydrostatic pressure at upper arm height, diagrammatic view;

FIG. 14 illustrates a diagrammatic view of the functional principle of the third exemplary embodiment;

FIGS. 15a-15b illustrate a diagrammatic view of a ninth exemplary embodiment of a cuff, cross section, as follows:

a. deactivated

b. activated.

### DETAILED DESCRIPTION OF THE DRAWINGS

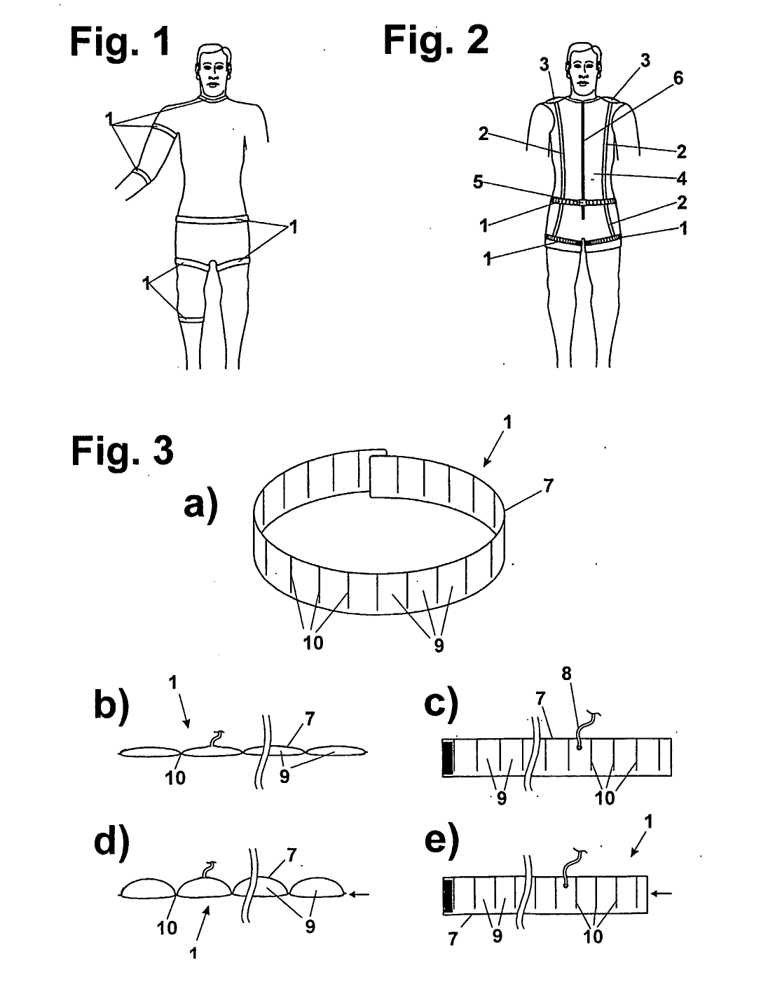

FIG. 1 shows a first exemplary embodiment of an acceleration protection or even anti-G device according to the invention, wherein one side of the wearer on FIG. 1 is additionally equipped with protective devices on one arm and one lower leg to illustrate the various capabilities. In documents according to prior art, it is usual to increase the internal pressure in the lower body region via technical devices. By contrast, the inventive idea of this invention is to use tightly fitting cuffs I with shortenable inner circumference to immediately tie off body regions under the cuffs 1 in the event of critical G₂ acceleration forces, so as to prevent the blood from flowing off into lower-lying body parts. As a result, the pressure critical for oxygen supply, and hence for preventing a G-LOC, can drop less quickly at head level. The venous blood is prevented from flowing back into the legs, and a sufficiently constricted cuff 1 will also not allow the inflow or outflow of arterial blood in the tied off areas. As shown in FIG. 1, cuffs I are placed in the waist area and/or as far to the top as possible on both upper legs. The cuff 1 in the waist area should here be positioned over the pelvis to exert the desired tying effect without the pelvic bones posing any impediment. FIG. 1 shows other locations for affixing anti-G cuffs 1. For example, the neck, as far up the upper arm as possible, over or under the elbow, and over or under the knee. The body, and hence the bodily fluid column, is segmented with the help of the cuffs 1 in the direction of the acceleration forces, wherein the cuffs 1 are essentially arranged in a plane normal to the direction of acceleration. Tying off under a G₂-load divides the blood column into smaller pieces, as a result of which the maximal blood pressure under a G₂-load decreases according to the hydrostatic formula
ρ·g·h=p (1)
since the maximum possible column height is reduced, wherein the following applies: ρ is the specific density of the liquid [kgm⁻³]; g is the acceleration [ms⁻²]; h is the height of the liquid column [m]; p is the pressure in the liquid column [Pa].

The cuffs 1 can be worn individually and independently of each other according to FIG. 1.

However, it is more practical to integrate the cuffs 1 in an article of clothing, e.g., into underwear or an overall. As a result, the anti-G cuffs 1 can be readily tightened, and are always correctly positioned. Also conceivable according to the invention is to connect one cuff 1 around the waist with two cuffs 1 around each upper leg, resulting in a combination, e.g., similar to a seat belt for sport climbers. The cuffs 1 are here connected to each other by means of belts or bands, and thereby held in their desired position, and can be slipped on like a pair of shorts. The expert knows of other ways in which such cuffs I can be integrated into existing clothing, or how cuffs 1 can be worn as comfortably as possible over or under the clothing. Therefore, we will not go into any further detail into the various potential embodiments. The important thing here is for the cuffs 1 not to slip to such an extent as to impair their correct and complete clamping effect, and that tying off take place at the desired location.

FIG. 2 shows a second exemplary embodiment of an acceleration protection device according to the invention. The cuffs 1 that can be shortened with fluidic means in this example are placed under a hydrostatic pressure, during which the pressure generated by the liquid column for actuating the cuff 1 rises as the G₂-loads increase. The liquid column is formed by flexible hoses 2 that are essentially not extensible in the transverse and longitudinal directions, and a liquid reservoir 3 situated above. The maximum liquid column height h is achieved by placing the liquid reservoir 3 at the shoulder level. This yields liquid column heights of roughly half a meter. If less pressure is sufficient for constricting the cuffs 1, the liquid reservoir 3 can be arranged further down, e.g., in the chest area. In the event more pressure is required, the liquid column can be elongated beyond shoulder level by securing the liquid reservoir 3 over or next to the head of the wearer on the cockpit structure, and connecting it with the cuffs 1 by means of a coupling piece. In addition to varying the liquid column height h, the parameters specific density ρ and viscosity of the liquid can be adjusted through the selection of different liquids. The product of ρ, G₂ (normal gravitational acceleration approx. 9.81 ms⁻²) and h results in the rise in linear G₂ dependence for pressure p in the liquid column, which is available for engaging one or more fluidic actuators for constricting the cuff. In a liquid column of half a meter, when using water, +1 G_{z} yields a pressure p of approx. 49 hPa, while +10 G_{z} yields approx. 490 hPa. This can be compared to a physiologically very high systolic blood pressure of 266 hPa (200 mmHg), which the cuff 1 is to counteract at high G₂ loads. Since the blood circulation in the body is also a liquid column subject to principles of hydrostatics, a difference is required between the density of blood and density of liquid in the anti-G device to tie off the blood vessels and compensate for the blood pressure, unless the hydrostatic pressure in the fluidic actuators is not additionally increased using the means described further below.

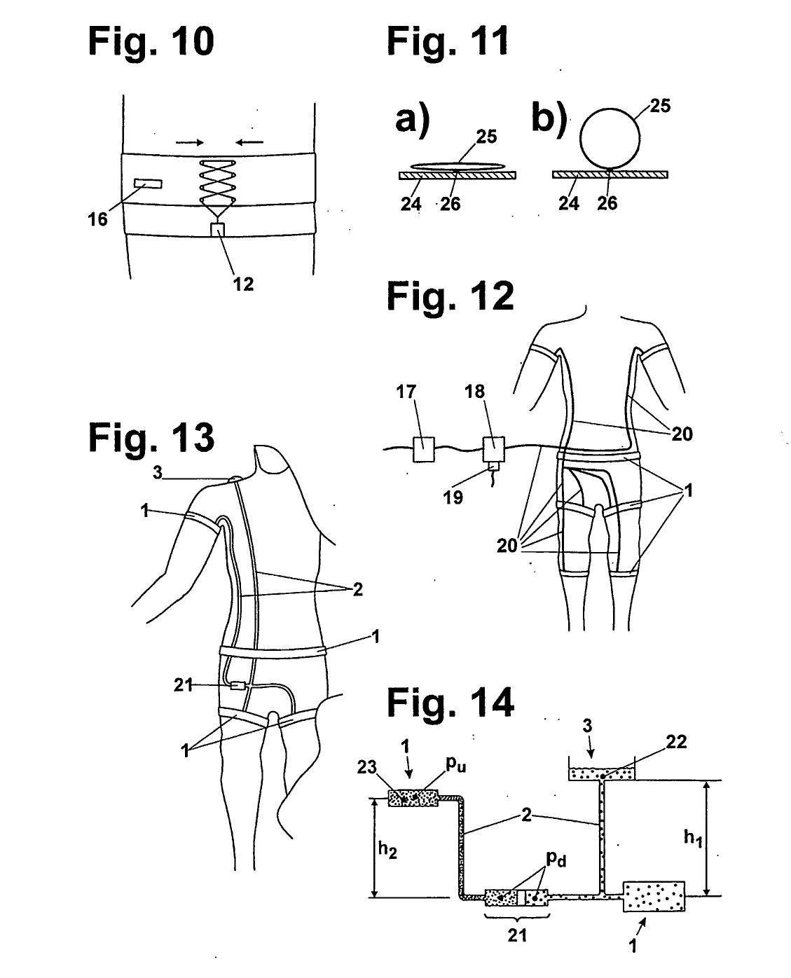

As shown in FIG. 2, there are three cuffs 1, two of which envelop each upper leg, while the third wraps around the waist of the wearer. As one possible example, the cuffs I are shown here integrated in an armless and short-legged undergarment combination 4, e.g., made out of cotton or synthetic fibers. The cuff 1 around the waist can be opened to slip on and off by means of a buckle and zipper 6. The cuff width, and hence the circulating tension of the cuff 1, can be tailored to the body structure and dimensions of the wearer using adjusting devices, e.g., Velcro fasteners or belt-buckle combinations. To ensure that the cuffs 1 interrupt the blood flow at the desired +G_{z} load, they must exhibit a circulatory tension dependent on ρ and h, as well as on the blood pressure of the wearer, at +1 G_{z}. For example, this tension can be measured via the tension sensors 16 integrated into the cuff 1, as shown in FIG. 10. It also makes sense to dimension the adjusting device for the cuff circumference in such a way that makes it possible to restore a setting once optimized, and only introduce adjustments in body mass and blood pressure based on tables. A tension sensor 16 integrated into the cuff 1 can also be helpful in setting an optimal length for the cuff 1, e.g., an expansion measuring strip, the measured values from which can be output by an external output device. For example, an LED display or a diode that turns green once a desired basic tension has been established is conceivable.

In the exemplary embodiment, the cuffs 1 themselves are designed as fluidic muscles. The cuff I in the waist area is connected above with two separate, essentially inelastic hoses 2 with two liquid reservoirs 3 in the shoulder area, and below with two other hoses 2 with the cuffs 1 in the upper leg area. The liquid in the liquid reservoirs 3 is used to compensate for the increase in liquid volume given a pressure increase in cuffs I and hoses 2, without the hydrostatically active height of the liquid column h decreasing significantly.

FIGS. 3a-3c show a cuff 1 of the kind used in the second exemplary embodiment. The cuff 1 essentially consists of a liquid-tight hose-like bag 7, which can be filled with liquid and overpressurized through at least one valve 8. The bag 7 is made out of sparingly extensible, flexible material, for example aramide-reinforced plastic, and divided into several communicating chambers 9 in the longitudinal direction. The chambers are formed by linear, non-positive connections 10 between the walls of the bag 7 in a transverse direction, e.g., by sealed darts or weld seams. However, the seams do not traverse the entire width of the bag 7, so that the liquid can flow from one chamber 9 into adjacent chambers 9. As a result the same liquid pressure prevails in all chambers 9 of a cuff. The connection 10 can consist of several punctiform or linear joining points lying on a line, as shown on FIG. 5.

FIG. 3a shows a first exemplary embodiment of the cuff I closed into a circle, isometric view. The FIGS. 3b and 3d show the open, longitudinally elongated cuff 1 in longitudinal section, while FIGS. 3c and 3e show a top view. Because the cuff 1 was pressurized in FIGS. 3d and 3e, it exhibits a shortened length. Assuming that the chambers assume an approximately circular shape when pressurized, the theoretical maximum shortening measures 2/π˜64% of the length of the stretched out empty cuff 1.

$$\frac{D}{U / 2} = \frac{D}{( D \cdot π ) / 2} = \frac{2 \cdot D}{D \cdot π} = \frac{2}{π} \approx 64 \% \qquad ( 2 )$$

where D is the diameter, and U is the circumference.

Of course, the expert can find numerous other alternative ways of designing a cuff 1 with the function described above. For example, the chambers 9 can be fabricated by sewing together a textile hose, after which fluid-tight bubbles, which can also be elastic as opposed to the bag 7, can be placed in the non-fluid-tight chambers 9.

Instead of crossing the entire cuff 1, pressure can be exerted by shortening only the inner circumference or constricting the inner diameter of the cuff I at an essentially constant outer diameter to achieve the tying-off effect. Such an effect is achieved, for example, with a cuff 1 essentially fabricated out of inelastic material, the inside of which accommodates flexible pressure chambers that can be pressurized, for example, hoses.

Instead of hydraulic actuation, cuffs 1 with fluidic actuators can also be operated with compressible fluids, such as, for example, compressed air. Compressed air-operated G-suits represent state of the art. Many aircraft are equipped with G₂ sensors and control/regulating electronics as well as compressors and pressurized vessels for providing compressed air at higher G₂ loads, and hence for operating compressed air G-suits. Software adaptations of the control characteristic make it possible to use these existing systems for operating anti-G cuffs 1 using compressed air. The cuffs 1 are directly supplied with compressed air, and the liquid reservoir 3 is omitted.

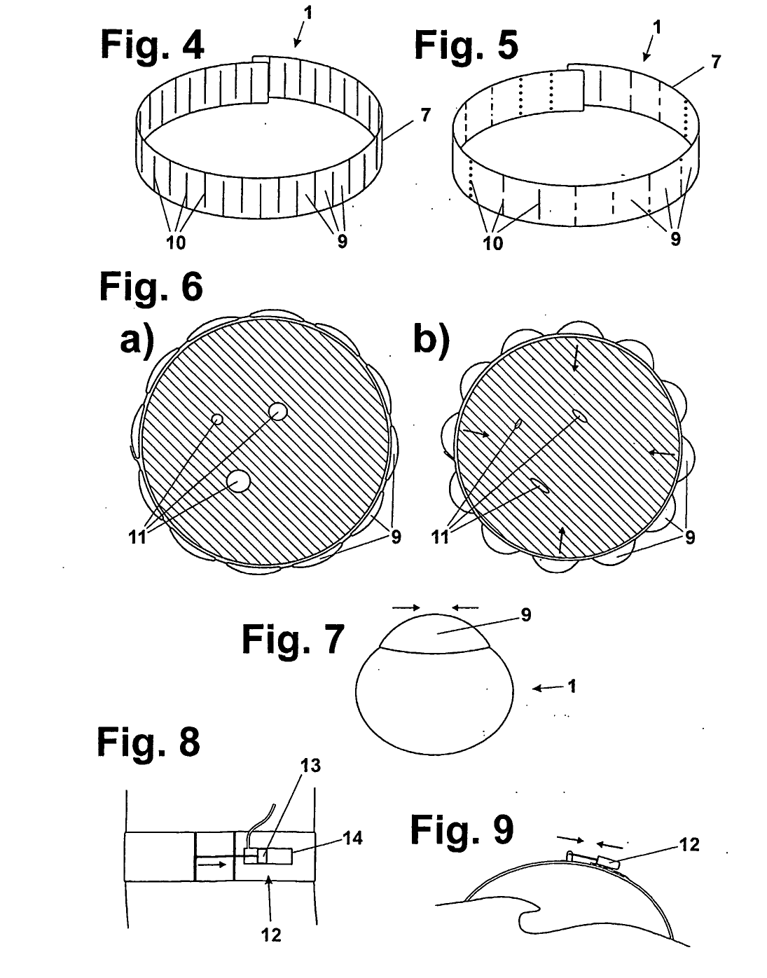

FIGS. 4 and 5 show additional exemplary embodiments for the connections 10. The passages necessary in linear connections 10 for compensating the pressure between the chambers 9 can be alternately arranged on either side, as shown on FIG. 4.

FIG. 5 shows some additional possible examples for configuring the connection 10 on a cuff 1. All intermediate stages from one connection 10 consisting of several punctiform connections lying on a single line to a continuous, 1 linear connection 10 with at least one passage, are conceivable according to the invention, as long as the function of the cuff 1 as a fluidic muscle is ensured.

FIGS. 6a and 6b show how the cuff 1 shown in FIG. 3 operates when placed around a body part. FIG. 6a shows the cuff 1 not pressurized, and FIG. 6b shows it pressurized. Shown diagrammatically in cross section is a body part, blood vessels 11, which are compressed with the cuff 1 shortened on FIG. 6b, thereby impeding to preventing blood circulation.

FIG. 7 shows a fluidic cuff I with only one large chamber 9. Such a cuff 1 generates a larger circulation tension in the cuff 1 than several small chambers 9 with correspondingly smaller diameters at the same pressure of the pressure fluid contained therein.

FIG. 8 shows a fifth exemplary embodiment of a cuff 1. This example works with any linear actuator 12 according to prior art. A hydraulically or pneumatically operated actuator with pistons 13 and cylinder 14 is shown as an example. Pistons 13 and cylinders 14 are shown in cross section. A tensioning element 15 is used to shorten the cuff 1 under exposure to pressure by the pistons 13 moving in the cylinder 14. The expert knows of numerous ways in which the cuff 1 can be shortened by means of an actuator 12, e.g., any electric actuator. Similarly to FIG. 2, such a cuff 1 can also be actuated hydrostatically. A cuff 1 according to the invention can also be fabricated using shortenable fibers, e.g., electrorestrictive material.

FIG. 9 shows a side view of a sixth exemplary embodiment of a cuff 1, wherein the actuator 12 can be any linear actuator, e.g., one driven by an electric motor.

FIG. 10 shows a seventh exemplary embodiment of a cuff 1 as an example for other possible mechanical designs of the shortening mechanism of the cuff 1. In the exemplary embodiment shown on FIG. 10, the cuff I is shortened with a cable pull 12, similar to a shoelace. Secured to the cuff 1 is a tension sensor 16, e.g., an expansion-measuring strip. Such a tension sensor 16 can be incorporated into all cuffs 1 according to the invention, so that the state or tension of the cuff I can be acquired and measured given an electronically controlled and regulated acceleration protection device, and the desired blood circulation can be suppressed accordingly based on a rising G₂ load. In addition, such a tension sensor 16 as mentioned above can also be used to tailor the tension of the cuff I when the device is put on the body of the wearer. In order to properly function, the cuff 1 must exhibit a specific base tension in the base state, e.g., at gravitational acceleration 1 G. If the cuff 1 is too loose, it exerts its tying-off effect either too late or not at all; by contrast, if too snug, its tying-off effect sets in too early, or blood circulation is even impeded in the base state, at 1 G. For purposes of setting the base tension, the tension sensor 16 can also consist of a simple mechanical force transducer, and be combined with a display and scale.

FIGS. 11a and 11b shows an eighth exemplary embodiment of a cuff 1 in diagrammatic cross section. This exemplary embodiment functions according to a principle different than the preceding embodiments. The internal pressure in the tied-off body part is not achieved by drawing together the cuff 1, but by increasing the pressure in a pressure chamber 25 secured to the inside of an essentially inelastic band 24 by means of a longitudinal connection 26, e.g., a flexible hose. FIG. 11a shows the cuff 1 with flat-pressed pressure chamber 25, without any tie-off effect, and FIG. 11b shows the cuff 1 with a pressurized chamber 25, and hence shortened inner circumference of the cuff 1.

FIG. 12 provides a diagrammatic view of which elements exhibit an electronically controlled acceleration protection device for actuating, controlling and regulating the cuffs 1. The electronic control and regulating device can be designed as a component to be worn on the body, or as a module installed in the cockpit. A G_{z}-sensor 17 provides a programmable computer 18 with the current acceleration data in the Z-direction. The computer 18 can additionally be provided with measuring data from a tension sensor 16 about the tension status of the cuff 1 and/or additional flight status data, e.g., control stick setting, accelerator pedal setting and flight speed. The latter flight status data can be used to anticipate arising G_{z}-acceleration peaks in advance, thereby permitting an immediate protective effect of the anti-G cuffs 1. The computer 18 has an interface 19 which can be used to hook up an external computer. For example, this makes it possible to load new or modified programs or data tables on the one hand, and externally log and record measuring and operating parameters for the acceleration protection device on the other. Lines 20 are on hand for transporting the measuring data and control commands. For example, data transmission can be initiated by means of a bas system. Depending on the type of actuator 12, the acceleration protection device requires additional components, such as a compressor, a pressure tank, pressure lines, a distribution unit for the hydraulic fluid. The expert derives these parts from prior art and his own general expertise, so that the particularities involved in the various potential embodiments will not be taken up in any greater detail here.

As shown in FIG. 2, one major advantage to a hydrostatically operated and controlled cuff 1 is that the acceleration protection device functions autonomously and without outside energy, makes do without a control and regulating device, is low-maintenance and breakdown-proof, and can be used in any type of aircraft without modification and adjustment.

FIG. 13 and FIG. 14 show a third exemplary embodiment of an acceleration protection device according to the invention. Since the height difference between the shoulder and upper arm is small, and hence only permits a small hydrostatic pressure, it is necessary to enhance the hydrostatic pressure pᵤ in the cuff 1 on the upper arm. This enhancement can be achieved, for example, with a dual-action hydraulic piston-cylinder arrangement 21, which is positioned in the area of the waist or upper leg, and by using two varyingly dense liquids 22, 23 with the specific densities ρ₁ and ρ₂. The liquid reservoir 3 on the shoulder is filled with the heavier liquid 22, which generates a hydrostatic pressure Pd in the piston-cylinder arrangement 21. The second, lighter liquid 23 fills the hoses 2 and cuff 1 in the upper arm area, and has the primary job of relaying the hydrostatic pressure to the cuff 1 placed in the upper arm as undiminished as possible through self-induced hydrostatic effects. An incompressible fluid with the lowest possible specific density is ideally used. The specific densities for the liquids can be varied based on the actual existing heights h₁ and h₂, so as to achieve the pressures necessary for clamping off the blood vessels both the upper arm and the level of the upper leg. The following calculation example is intended to illustrate the principle. The heavy liquid 22 is glycerin (ρ₁=1,260 kgm⁻³), the lighter liquid 23 is water (ρ₂=1,000 kgm⁻³). The following applies:
ρ₁gh₁=ρ₂gh₂+pᵤ (3)
From the above, it follows for pu:
pᵤ=g(ρ₁h₁−ρ₂h₂) (4)
The following values are assumed for the liquid column levels: h₁=0.5 m and h₂=0.25 m. At Gz=+1 G, this yields pu˜37 hPa, while the cuff on the upper arm is pressurized with pᵤ˜373 hPa at G_{z}=+10 G (ass opposed to pᵤ˜309 without reinforcement), while a pressure pd˜618 hPa is measured at the level of the piston-cylinder arrangement 24. This calculation example is based on a purely statistical approach. All friction losses in the lines 2 and piston-cylinder arrangement 21 that also influence the dynamics and adjustment characteristics of the acceleration protection device given changes in g are disregarded. For example, the piston-cylinder arrangement 21 can also be replaced by a liquid-tight, elastic membrane in a container, which separates the liquids of varying density 22, 23 from each other, and enables a pressure equalization between the two liquids 22, 23.

Another way to increase pressure in hydrostatically operated cuffs 1 involves providing the dual-action piston-cylinder arrangement 21 with different active piston surfaces, which increases the pressure in proportion to the ratio between the two active piston surfaces. For example, if the active piston surface on the side of the fluidic actuator is half as large as the countering active piston surface, the pressure is doubled.

In pneumatically operated cuffs 1, the bag 7 can be partially perforated to exert a ventilating effect on the side of the covered body parts facing the body. The liquid expressed by the body evaporates permanently, and can be transported away by the air stream. This increases the wearing comfort of the device, and prevents the formation of wet perspiration spots in the area of the cuff, which is made out of airtight material, and hence does not actively breathe.

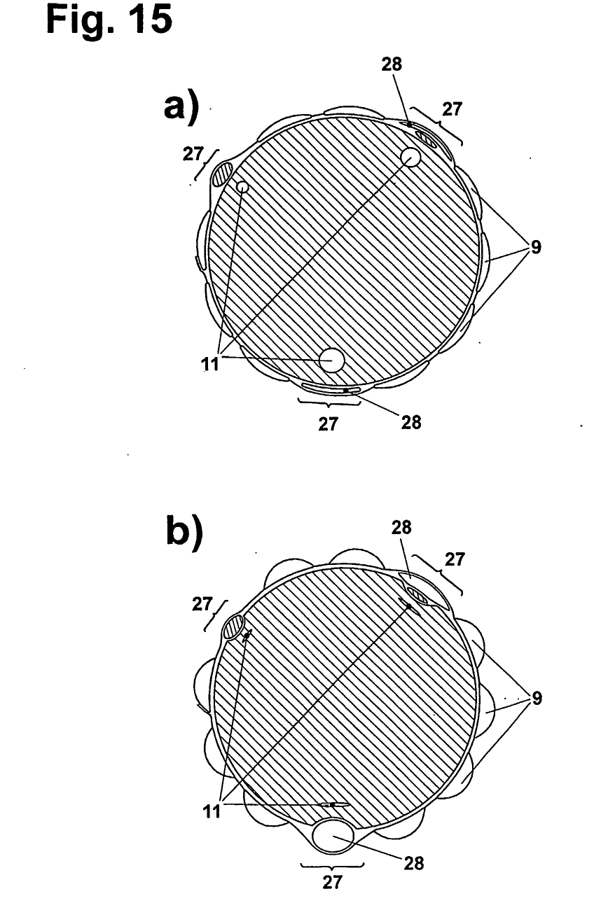

FIGS. 15a and 15b present diagrammatic views of a ninth exemplary embodiment of a cuff 1. FIG. 15a shows a section through a cuff 1 enveloping a body part in a deactivated state, while FIG. 15b shows the same in an activated state. The cuff 1 has at least one pressing unit 27 to exert an elevated local pressure on the enveloped body part at specific points.

This embodiment is useful in parts of the body that exhibit important blood vessels 11 near the surface. For example, blood vessels 11 can be specifically constricted in the case of cuffs 1 placed around the neck, without simultaneously tying off the trachea completely.

A pressing unit is secured, for example, on the side of the cuff 1 facing the body in order to specifically constrict a blood vessel 11, e.g., an artery. This pressing unit 27 can be made out of both a solid, essentially non-deformable material, as well as out of an elastic material. As the cuff 1 is constricted, the pressing unit 27, similarly to a medical compression bandage, is pressed against the underlying blood vessel 11, and prevents or inhibits blood flow through the blood vessel 11. For purposes of illustration, FIG. 15 shows three different examples for the design of such pressing units 27 in a cuff 1. The pressing unit 27 can be designed and tailored to the bodily structure of the wearer in such a way as to optimize the blood flow-suppressing effect.

The shapes are not limited to the ones shown on FIG. 15.

It is conceivable for the length of the cuff 1 to remain unchanged, and only have the pressing unit 27 press to more or less of an extent against the body by actively changing its geometry. This change in contact pressure can be initiated both mechanically and fluidically. For example, the contact pressure can be initiated mechanically by means of an actuator integrated in the pressing unit 27, wherein this actuator can increase the expansion of the pressing unit 27, thereby pressing it against the body. The contact pressure can be increased fluidically by entirely or partially designing the pressing unit 27 as a pressurized cavity 28 made out of flexible material, for example, wherein the volume of this cavity 28, and hence the volume of the entire pressing unit 27, is increased during pressurization, as a result of which the pressing unit 27 is locally pressed against the body part.

Various embodiments of the invention may include one or more of the special features of the different aforementioned exemplary embodiments to yield other variants.

1. A device for protecting a human body against acceleration effects, the device comprising:
at least one cuff comprising means for locally increasing the internal pressure of a body part enveloped by the cuff, wherein an inner circumference of the at least one cuff can be decreased given acceleration forces exceeding 1 G;
wherein the cuff is placed around the body part in a plane essentially normal to a arising acceleration forces, thereby dividing the body into a plurality of segments in a direction of the arising acceleration forces, and, when tied off at a locally elevated internal pressure, can at least limit flow of bodily fluids through a level defined by the cuff from one segment to an adjacent segment.

2. The device for protecting a human body against acceleration effects according to claim 1, further comprising means for shortening an inner circumference of the cuff abutting the body part by thickening a cross section of the cuff while simultaneously maintaining a constant outer circumference.

3. The device for protecting a human body against acceleration effects according to claim 1, further comprising means for shortening the inner circumference of the cuff abutting the body part by constricting the cuff.

4. The device for protecting a human body against acceleration effects according to claim 1, further comprising means for independently actuating the means for locally increasing the internal pressure of the body part enveloped by the cuff in the event of acceleration forces.

5. The device for protecting a human body against acceleration effects according to claim 3, wherein the cuff can be constricted using an actuator-driven shortening mechanism.

6. The device for protecting a human body against acceleration effects according to claim 1, wherein the inner circumference of the cuff abutting the body part can be shortened using a hydraulic fluid-driven actuator.

7. The device for protecting a human body against acceleration effects according to claim 5, wherein the inner circumference of the cuff abutting the body part can be shortened using an electric actuator.

8. The device for protecting a human body against acceleration effects according to claim 6, wherein the cuff is designed over at least a portion of is a length of the cuff as a liquid-tight bag;
wherein the bag comprises a valve, and is divided into a plurality of pressure-communicating chambers in a longitudinal direction via transverse connections of an inside surface and outside surface of the cuff, and the plurality of chambers act as a fluid muscle in the longitudinal direction responsive to the bag being pressurized and shorten the circumference of the cuff, and thicken the cuff to the inside.

9. The device for protecting a human body against acceleration effects according to claim 6, wherein the cuff is designed over at least a portion of its length as a membrane;
wherein the membrane is divided in a longitudinal direction into pockets via transverse connections of the inside surface and outside surface of the cuff;
wherein pressure communicating bags are incorporated into the pockets and the pressure-communicating bags can be pressurized via a valve;
wherein the pockets act in the longitudinal direction as a fluid muscle responsive to the bag being pressurized, shortening the circumference of the cuff and thickening the cuff to the inside.

10. The device for protecting a human body against acceleration effects according to claim 6, wherein air is used as a hydraulic fluid.

11. The device for protecting a human body against acceleration effects according to claim 6, wherein liquid is used as a hydraulic fluid.

12. The device for protecting a human body against acceleration effects according to claim 11, wherein the hydraulic fluid forms a liquid column, and is placed under a hydrostatic pressure in the event of accelerations, and the fluidic actuators are operated by the pressure arising at a lower end of the liquid column.

13. The device for protecting a human body against acceleration effects according to claim 12, wherein a fluidic actuator for constricting the cuff and a hydrostatic liquid column are provided; and
wherein a hose situated essentially in a direction of acceleration contains the liquid column and is connected by a valve at a lower end of the hose with the fluidic actuator.

14. The device for protecting a human body against acceleration effects according to claim 1, wherein at least one liquid reservoir is present at an upper end of the liquid column.

15. The device for protecting a human body against acceleration effects according to claim 11, wherein a pressure of a fluid for operating a fluidic actuator is amplified via a double piston with unequal active piston surfaces.

16. The device for protecting a human body against acceleration effects according to claim 11, wherein a hydrostatic pressure of a first fluid is relayed to an actuator via of a second, lighter fluid;
wherein the hydrostatic pressure is compensated between the first fluid and the second fluid via an elastic membrane or a double piston/cylinder arrangement, without the fluids being mixed together.

17. The device for protecting a human body against acceleration effects according to claim 1, further comprising means for controlling and regulating constriction of the cuff, as well as for measuring an instantaneous acceleration.

18. The device for protecting a human body against acceleration effects according to claim 1, further comprising means for measuring an instantaneous acceleration rate change.

19. The device for protecting a human body against acceleration effects according to claim 1, wherein the cuff is integrated into an article of clothing.

20. The device for protecting a human body against acceleration effects according to claim 1, wherein the cuff can be manually opened and closed.

21. The device for protecting a human body against acceleration effects according to claim 1, wherein a circumference and tension of the cuff can be manually changed.

22. The device for protecting a human body against acceleration effects according to claim 1, wherein the cuff constricts in proportion to acceleration.

23. The device for protecting a human body against acceleration effects according to claim 1, wherein an optimal tension for the cuff is displayed when placed around a body part.

24. The device for protecting a human body against acceleration effects according to claim 1, wherein distance marks are placed on the cuff for reproducible manual adjustment of a specific tension of the cuff when placed around a body part.

25. The device for protecting a human body against acceleration effects according to claim 1, further comprising a tension sensor and a tension display that measure and display a tension of the cuff when placed around a body part.

26. The device for protecting a human body against acceleration effects according to claim 1, wherein the cuff has at least one pressing unit.

27. A device for protecting a human body against acceleration effects, comprising:
at least one essentially inelastic cuff, the side of the cuff facing the body exhibits at least one pressing unit, with which a blood vessel can be specifically and actively constricted given acceleration forces exceeding 1 G by changing the geometric expansion of the pressing unit (27);
wherein the cuff is placed around a body part in a plane essentially normal to a rising acceleration forces, thereby dividing the body into several segments in a direction of the arising acceleration forces and, when tied off, can limit or entirely impede the flow of blood through the level defined by the cuff from one segment to an adjacent segment.

28. The device for protecting a human body against acceleration effects according to claim 26, wherein the pressing unit comprises a cavity that can be pressurized with a pressure fluid.

29. The device for protecting the human body against acceleration effects according to claim 9, wherein the membrane comprises a hose-like, essentially inelastic structure.
